(19) United States
(12) Patent Application Publication
(10) Pub. No.: US 2024/0320331 A1
(43) Pub. Date: Sep. 26, 2024

(54) MALWARE ANALYSIS SUPPORT SYSTEM AND MALWARE ANALYSIS SUPPORT METHOD

(71) Applicant: Hitachi, Ltd., Tokyo (JP)

(72) Inventors: Rei YAMAGISHI, Tokyo (JP); Shota FUJII, Tokyo (JP); Takayuki SATOU, Tokyo (JP); Katsuya NISHIJIMA, Tokyo (JP)

(21) Appl. No.: 18/453,140

(22) Filed: Aug. 21, 2023

(30) Foreign Application Priority Data
Mar. 20, 2023 (JP) 2023-044223

(51) Int. Cl. G06F 21/56; G06F 21/55

(52) U.S. Cl. CPC G06F 21/561; G06F 21/552

(57) ABSTRACT

In a malware analysis support system and a malware analysis support method of supporting a malware analysis, the analyst computer includes an analysis input unit configured to input analysis conditions of the malware analysis, an analysis purpose input unit configured to input analysis purpose information that is information corresponding to a malware analysis purpose included in the analysis conditions and collected through the malware analysis, and an analysis procedure suggestion unit configured to display an analysis procedure of the malware analysis, the analysis computer includes a recommended analysis procedure creation unit configured to execute a process for calculating the analysis procedure to be recommended to the user on a basis of the analysis conditions, the analysis purpose information, a past analysis procedure, and a current analysis procedure, and the analysis procedure suggestion unit recommends, to the user, the analysis procedure calculated by the recommended analysis procedure creation unit.

### BACKGROUND OF THE INVENTION

### Field of the Invention

The present invention relates to a malware analysis support system and a malware analysis support method.

### Description of the Related Art

To prevent cyber-attacks conducted using malicious software (malware), a cyber countermeasure is generally taken by grasping a function and a behavior of malware. Such a malware analysis is performed as part of information security. As an example of an information security inspection, International Publication No. WO 2021-124538 discloses a technique in which an inspection support apparatus receives information related to activity histories for security inspections performed by a plurality of inspection apparatuses, specifies a conforming condition from the received activity histories, and generates related activity history, thereby enabling a security inspection to be efficiently performed.

An analysis procedure of malware analysis changes in a complicated manner according to analysis conditions such as an analysis purpose, desired information, a malware family to be analyzed, a version, and an analysis environment. The analysis procedure may vary even in the case where the same malware is analyzed. For example, in the malware analysis for the purpose of update of blacklist, the analysis procedure is presented to obtain a file hash, or a domain or an IP address of an attacker server serving as a connection destination, whereas in the malware analysis for the purpose of restore after malware infection, the analysis procedure is presented to obtain information about malware removal.

Thus, considering that the analysis procedure varies according to the analysis conditions in the malware analysis, the technique disclosed in International Publication No. WO 2021-124538 in which an activity is generated on the basis of only activity histories, which produces a problem in that a malware analysis cannot be efficiently performed.

### SUMMARY OF THE INVENTION

In a malware analysis support system which supports a malware analysis of a user using an analyst computer and an analysis computer, the analyst computer includes an analysis input unit configured to input analysis conditions of the malware analysis, an analysis purpose input unit configured to input analysis purpose information that is information corresponding to a malware analysis purpose included in the analysis conditions and collected through the malware analysis, and an analysis procedure suggestion unit configured to display an analysis procedure of the malware analysis, the analysis computer includes a recommended analysis procedure creation unit configured to execute a process for calculating the analysis procedure to be recommended to the user on a basis of the analysis conditions, the analysis purpose information, a past analysis procedure, and a current analysis procedure, and the analysis procedure suggestion unit recommends, to the user, the analysis procedure calculated by the recommended analysis procedure creation unit.

According to the present invention, there can be provided a malware analysis support system and a malware analysis support method enabling a malware analysis to be efficiently performed while reflecting the conditions of the malware analysis.

### BRIEF DESCRIPTION OF THE DRAWINGS

FIG. 1 is a diagram illustrating an example of a hardware and software configuration of a malware analysis support system according to a first embodiment of the present invention;

FIG. 2 is a diagram illustrating an example of a functional configuration diagram of an analysis computer in FIG. 1;

FIG. 3 is a diagram illustrating an example of a functional configuration diagram of an analyst computer in FIG. 1;

FIG. 4 is a diagram illustrating an example of an analysis screen displayed on the analyst computer in FIG. 1;

FIG. 5 is a diagram illustrating an example of a data configuration of an analysis history table in FIG. 2;

FIG. 6 is a diagram illustrating an example of a data configuration of an analyst purpose table in FIG. 2;

FIG. 7 is a diagram illustrating an example of a data configuration diagram of an analyst procedure table in FIG. 2;

FIG. 8 is a diagram illustrating an example of a sequence diagram illustrating the overall process, according to the first embodiment of the present invention;

FIG. 9 is a diagram illustrating an example of a flowchart illustrating an analysis input process in FIG. 8;

FIG. 10 is a diagram illustrating an example of a flowchart illustrating an analysis purpose information input process in FIG. 8;

FIG. 11 is a diagram illustrating an example of a flowchart illustrating a malware analysis procedure support process in FIG. 8;

FIG. 12 is a diagram illustrating an example of a flowchart illustrating a recommended analysis procedure creation process in FIG. 11;

FIG. 13 is a diagram illustrating an example of a flowchart illustrating an analysis procedure suggestion process in FIG. 8;

FIG. 14 is a diagram illustrating an example of a sequence diagram illustrating the overall process, according to a second embodiment of the present invention;

FIG. 15 is a diagram illustrating an example of a flowchart illustrating an analysis purpose information recommendation process in FIG. 14; and

FIG. 16 is a diagram illustrating an example of a flowchart illustrating a recommended analysis purpose information input process in FIG. 14.

### DETAILED DESCRIPTION OF THE PREFERRED EMBODIMENTS

Hereinafter, the embodiments for carrying out the present invention will be explained with reference to the accompanying drawings. The following description together with the accompanying drawings are intended for exemplarily explaining the present invention, and to clarify the explanation, omissions and simplifications are made where appropriate. The present invention can be implemented in other various forms. Unless otherwise specifically limited, the number of each component can either be singular or plural.

To facilitate the present invention to be understood, the position, size, shape, range and the like of each component illustrated in the drawings, in some cases, do not represent the actual position, size, shape, range and the like thereof. Thus, the present invention is not necessarily limited to the positions, sizes, shapes, ranges and the like thereof disclosed in the accompany drawings.

For example, each piece of information is explained with the expressions such as “table”, but such each piece of information may be expressed with the data structure other than mentioned above.

### First Embodiment and Overall Configuration of the Present Invention

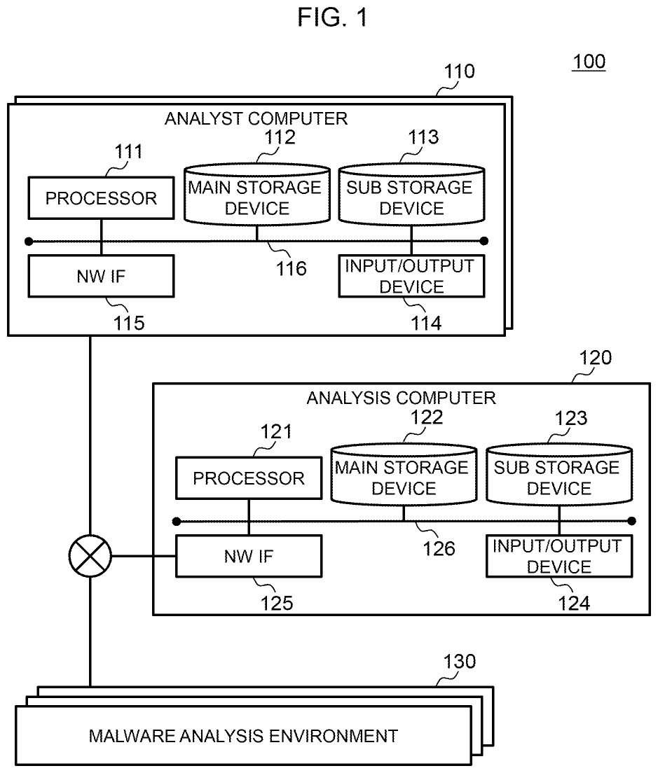

### (FIG. 1)

A malware analysis support system 100 includes an analyst computer 110, and an analysis computer 120, but may also include a malware analysis environment 130 for a malware analyst (user) to analyze malware.

The analyst computer 110 is a terminal operated by a user, and has functions of enabling the user to input analysis conditions, an analysis procedure and the like for a malware analysis, and presenting an analysis procedure to be recommended to the user. The analyst computer 110 includes, as a hardware configuration, a processor 111, a main storage device 112, a sub storage device 113, an input/output device 114, an NW IF 115, a bus bar 116 connecting these to one another, and the like. Note that the analyst computer 110 can be implemented by a general information processing device such as a server device, a personal computer, or a portable terminal.

The processor 111 controls each function unit of the analyst computer 110, reads data and a program stored in the sub storage device 113 into the main storage device 112, and executes a process determined by the program.

The main storage device 112 includes a volatile storage memory such as a random access memory (RAM), and stores a program to be executed by the processor 111 and data. The sub storage device 113 includes a nonvolatile storage element such as a hard disk drive (HDD) or a solid state drive (SSD).

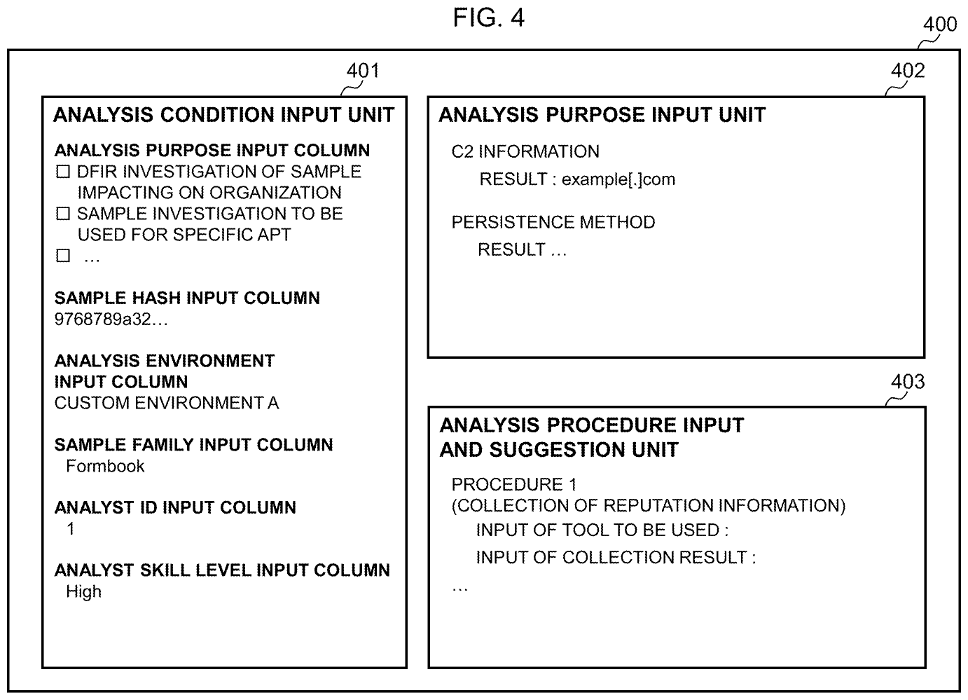

The input/output device 114 includes an input device such as a keyboard or a mouse, that accepts a user's operation, and an output device such as a touch panel, a display or a speaker, that displays information. The analyst computer 110 can use such an input device to acquire information input by the user's operation. The analyst computer 110 can use such an output device to display the input information on the screen, for example, thereby presenting the information to the user. An example of the information presented to the user is displayed on an analysis screen 400 in FIG. 4, which will be described later.

The NW IF 115 is connected to a network. The network connects the analyst computer 110, the analysis computer 120, and the malware analysis environment 130, so that the analyst computer 110 can transmit and receive data via the network.

The analysis computer 120 is a terminal operated by a user, and has functions of enabling the user to input conditions, a procedure and the like for a malware analysis, and presenting a procedure to be recommended to the user. The analysis computer 120 includes, as a hardware configuration, a processor 121, a main storage device 122, a sub storage device 123, an input/output device 124, an NW IF 125, a bus bar 126 connecting these to one another, and the like. Note that the analysis computer 120 can be implemented by a general information processing device such as a server device, a personal computer, or a portable terminal.

The processor 121 controls each function unit of the analysis computer 120, reads data and a program stored in the sub storage device 123 into the main storage device 122, and executes a process determined by the program.

The main storage device 122 includes a volatile storage memory such as a RAM, and stores a program to be executed by the processor 121 and data. The sub storage device 123 includes a nonvolatile storage element such as a hard disk drive (HDD) or a solid state drive (SSD).

The input/output device 124 includes an input device such as a keyboard or a mouse, that accepts a user's operation, and an output device such as a touch panel, a display or a speaker, that displays information. The analysis computer 120 can use the input device to acquire information input by the user's operation, and can use the output device to display the information on the screen, for example, thereby presenting the information to the user. An example of the information presented to the user is displayed on the analysis screen 400 in FIG. 4, which will be described later.

The NW IF 125 is connected to a network. The network connects the analyst computer 110, the analysis computer 120, and the malware analysis environment 130, so that the analysis computer 120 can transmit and receive data via the network NW.

The malware analysis environment 130 is an environment in which the user executes a malware analysis according to the analysis procedure recommended by the analyst computer 110, and is, for example, a sandbox. Note that the malware analysis environment 130 may be configured in a physical computer or a virtual environment, and may be included in the analyst computer 110, for example.

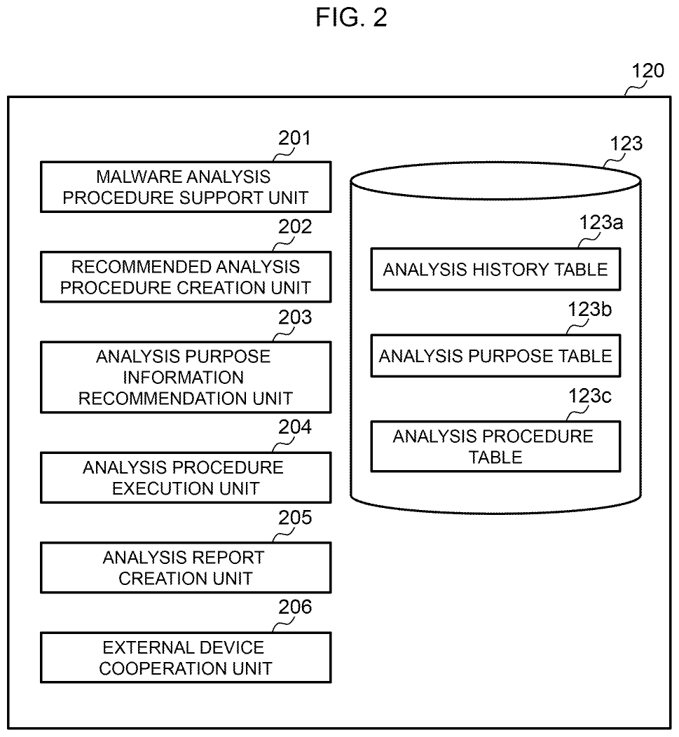

### (FIG. 2)

The analysis computer 120 includes, as function units, a malware analysis procedure support unit 201, a recommended analysis procedure creation unit 202, a analysis purpose information recommendation unit 203, an analysis procedure execution unit 204, an analysis report creation unit 205, and an external device cooperation unit 206. The sub storage device 123 of the analysis computer 120 stores an analysis history table 123a, an analysis purpose table 123b, and an analysis procedure table 123c. In the analysis computer 120, the above-described processor 121 reads a program stored in the sub storage device 123 into the main storage device 122, and executes each process.

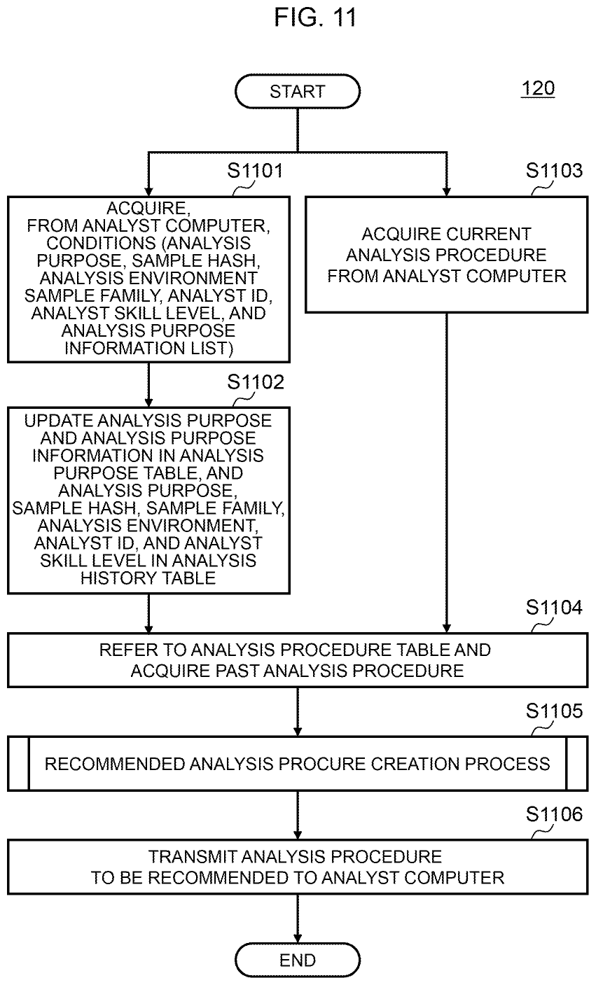

The malware analysis procedure support unit 201 executes a malware analysis procedure support process for recommending a malware analysis procedure to the user. The malware analysis procedure support process will be described later using FIG. 11.

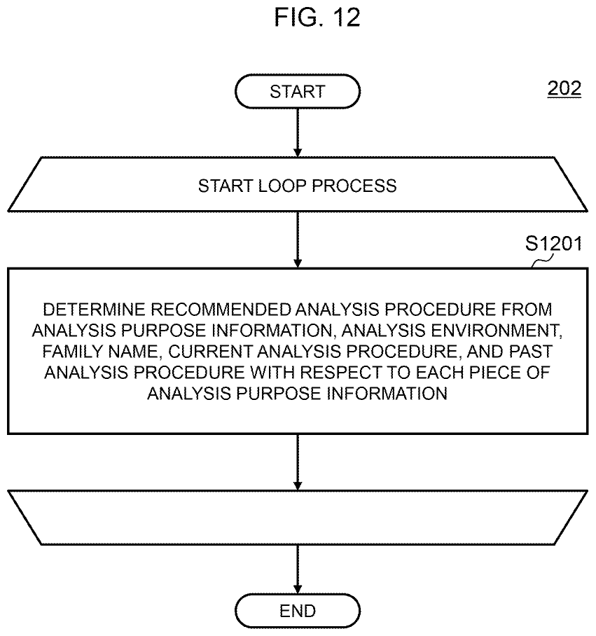

The malware analysis procedure creation unit 202 executes a recommended analysis procedure creation process of calculating a malware analysis procedure to be recommended to the user. The recommended analysis procedure creation process will be described later using FIG. 12.

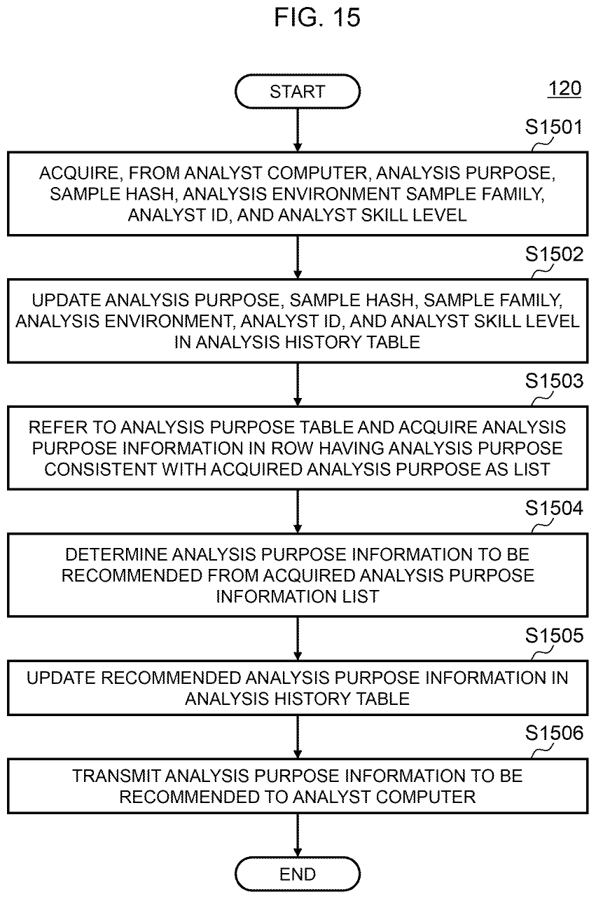

The analysis purpose information recommendation unit 203 executes an analysis purpose information recommendation process. The analysis purpose information recommendation process will be described later in a second embodiment (FIG. 15).

The analysis procedure execution unit 204 predefines a method of executing a part of a malware analysis procedure and automatically executes a malware analysis procedure according to the defined execution method for the purpose of reducing a burden imposed on the user. The analysis procedure execution process of the analysis procedure execution unit 204 will be described later in a third embodiment.

The analysis report creation unit 205 creates an analysis report on the basis of a template of the analysis report predefined for each malware analysis purpose and the information in the analysis procedure table 123c. The analysis report creation process used in the analysis report creation unit 205 will be described later in a fourth embodiment.

The external device cooperation unit 206 cooperates with an external security device. An external device cooperation process of the external device cooperation unit 206 will be described later in the fourth embodiment.

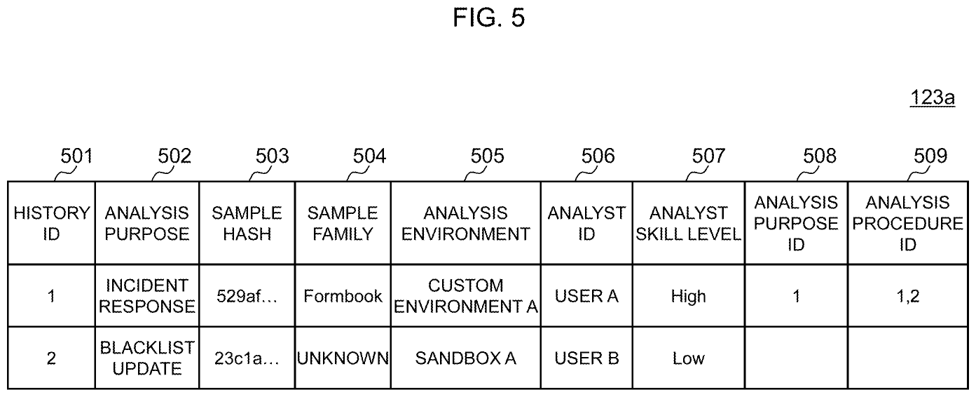

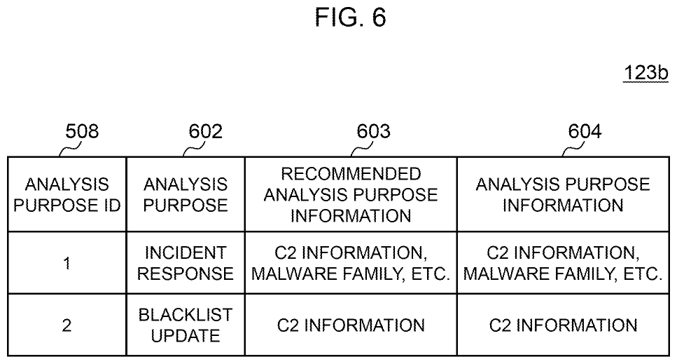

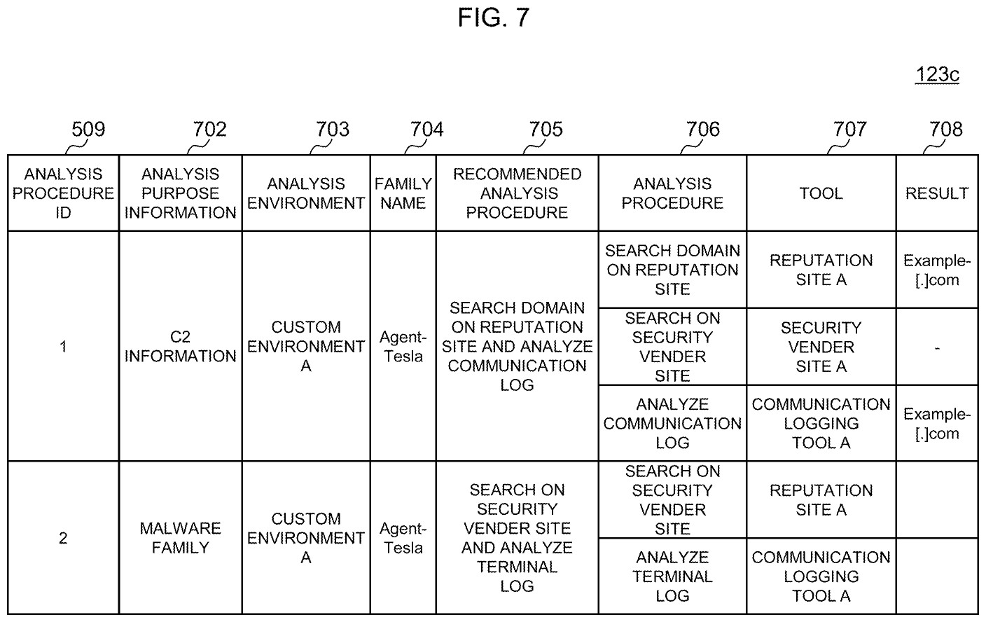

The analysis history table 123a of the sub storage device 123 of the analysis computer 120 will be described later in detail using FIG. 5. The analysis purpose table 123b will be described later in detail using FIG. 6. The analysis procedure table 123c will be described later in detail using FIG. 7.

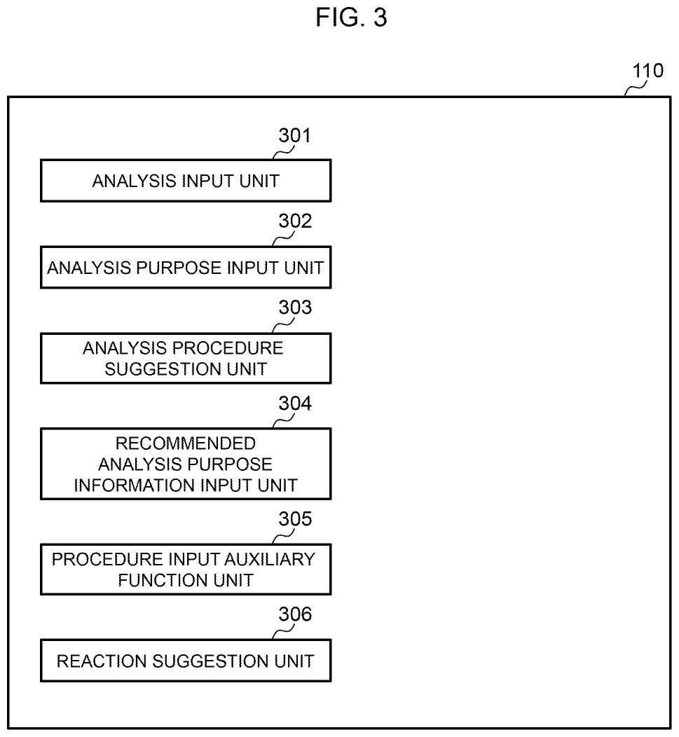

### (FIG. 3)

The analyst computer 110 includes an analysis input unit 301, an analysis purpose input unit 302, an analysis procedure suggestion unit 303, a recommended analysis purpose information input unit 304, a procedure input auxiliary function unit 305, and an reaction suggestion unit 306. In the analyst computer 110, the processor 111 reads a program stored in the sub storage device 113 into the main storage device 112, and executes each process.

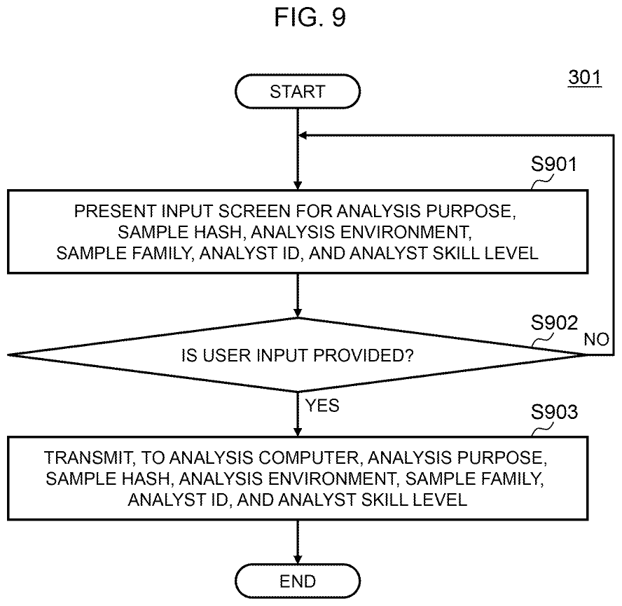

The analysis input unit 301 executes an analysis input process for the user to input analysis conditions related to a malware analysis. The analysis input process will be described later using FIG. 9.

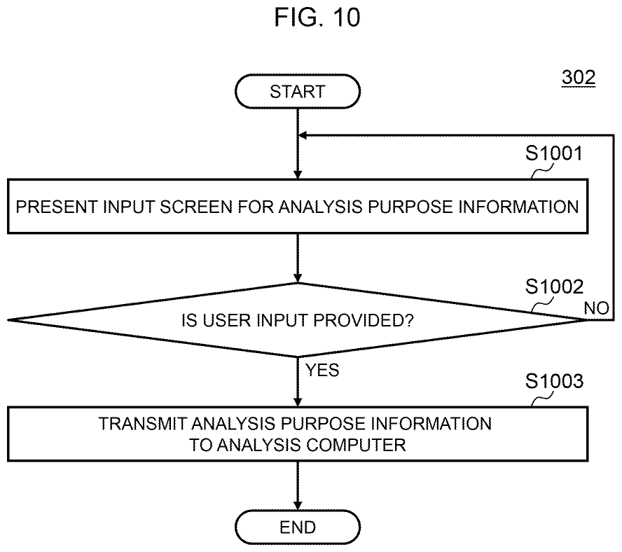

The analysis purpose input unit 302 executes an analysis purpose information input process for the user to input analysis purpose information set for the analysis purpose of the malware analysis. The analysis purpose information input process will be described later using FIG. 10.

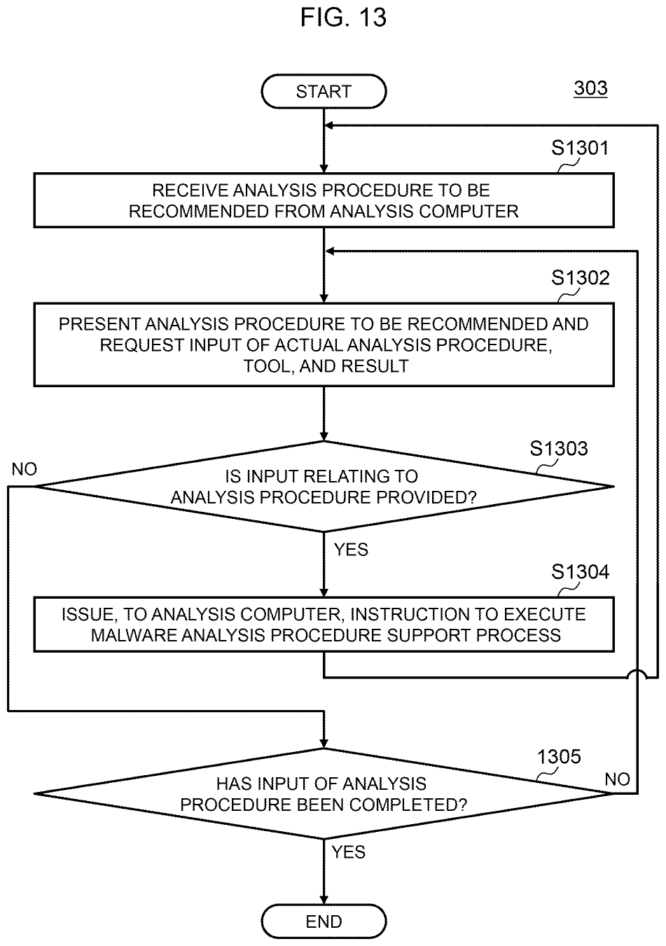

The analysis procedure suggestion unit 303 executes an analysis procedure suggestion process of outputting a malware analysis procedure to be recommended to the user. The analysis procedure suggestion process will be described later using FIG. 13.

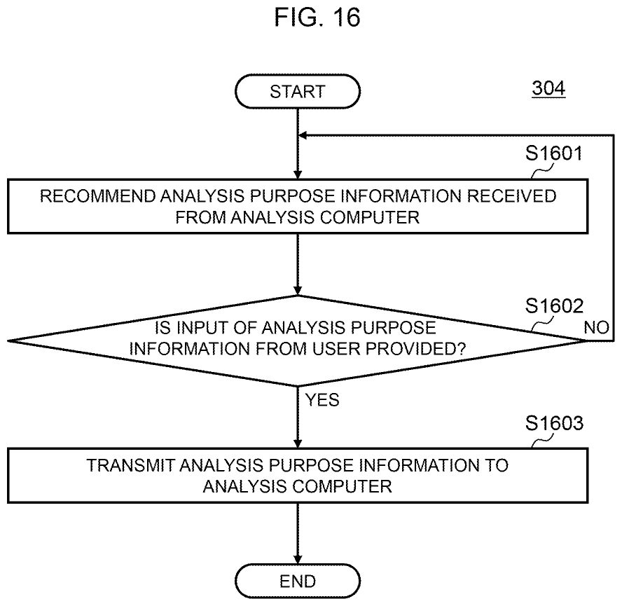

The recommended analysis purpose information input unit 304 executes a recommended analysis purpose information input process. The recommended analysis purpose information input process will be described later using FIG. 16 (second embodiment).

The procedure input auxiliary function unit 305 executes the procedure input auxiliary function process of tracking the work in the analyst computer 110 and automatically creating a current analysis procedure, for the purpose of reducing a burden imposed on the user. The procedure input auxiliary function process will be described later in the third embodiment.

The reaction suggestion unit 306 presents the analysis report created by the analysis report creation unit 205 (FIG. 2) and requests the user to determine whether to execute in the external device cooperation unit 206. The process of the reaction suggestion unit 306 will be described later in the fourth embodiment.

### (FIG. 4)

The analysis screen 400 displayed on the analyst computer 110 includes an analysis condition input unit 401, an analysis purpose information input unit 402, and an analysis procedure input and suggestion unit 403, and displays them to the user. The analysis screen 400 is implemented by, for example, an application in an execution form, a WEB page, or browser extension.

The analysis condition input unit 401 of the analysis screen 400 is a screen for accepting an input of each analysis condition necessary for the analysis input process (see FIG. 9) of the analysis input unit 301. Examples of the analysis conditions as used herein include an analysis purpose, a sample hash, an analysis environment, a sample family, an analyst ID, and an analyst skill level.

The analysis purpose information input unit 402 of the analysis screen 400 is a screen for accepting an input of analysis purpose information necessary for the analysis purpose information input process (see FIG. 10) of the analysis purpose input unit 302.

The analysis procedure input and suggestion unit 403 of the analysis screen 400 is a screen for outputting the recommended procedure in relation to the analysis procedure suggestion process (see FIG. 13) of the analysis procedure suggestion unit 303.

### (FIG. 5)

The analysis history table 123a stores information related to a malware analysis, the information being created for each analysis performed for the purpose of one malware analysis. The analysis history table 123a stores a record that contains, as fields, an analysis history ID 501, an analysis purpose 502, a sample hash 503, a sample family 504, an analysis environment 505, an analyst ID 506, an analyst skill level 507, an analysis purpose ID 508, and an analysis procedure ID 509.

The analysis history ID 501 is a field that stores an identifier assigned to uniquely identify one malware analysis. The analysis history ID 501 is assigned with a numeric character, as an example.

The analysis purpose 502 stores information related to an analysis purpose of the user to perform the malware analysis. The analysis purpose 502 includes, for example, incident response and blacklist update.

The sample hash 503 stores, as a hash value, information for identifying and storing malware to be analyzed. The hash value to be stored is SHA256 or MD5, for examples. Note that since the purpose of the sample hash 503 is to identify and store malware to be analyzed, an actual sample may be stored in another sub storage device by recording a path to the storage place of the actual sample.

The sample family 504 stores information related to a family and version of malware to be analyzed. The sample family 504 stores, for example, malware such as FormBook or AgentTesla. Note that when a family of malware to be analyzed is unknown, an instruction content indicating unknown, NONE, or the like may be stored in the sample family 504.

The analysis environment 505 is a field that stores information related to the malware analysis environment 130. The analysis environment 505 stores a sandbox name, an analysis environment name, or an identifier assigned to identify the environment, for example.

The analyst ID 506 is a field that stores an identifier assigned to uniquely identify a user who has performed the malware analysis. The analyst ID 506 is assigned with a numeric character, as an example.

The analyst skill level 507 is a field that stores information about a skill level of the user who has performed the malware analysis with respect to the analysis for the purpose of determining the validity of the malware analysis procedure. The analyst skill level 507 stores a word such as High or Low representing the skill level, or a numerical value representing the skill level, for example.

The analysis purpose ID 508 is a field that stores an identifier assigned to uniquely identify a field of the analysis purpose table 123b related to the malware analysis that is being performed. A column for the analysis purpose ID 508 in the analysis purpose table 123b in which the same value as a value of the analysis purpose ID 508 in the analysis history table 123a is stored is considered to show an associated analysis purpose. The analysis purpose ID 508 is assigned with a numeric character, as an example.

The analysis procedure ID 509 is a field that stores an identifier assigned to uniquely identify a field of the analysis procedure table 123c related to the malware analysis that is being performed. A column for the analysis procedure ID 509 in the analysis procedure table 123c in which the same value as a value of the analysis procedure ID 509 in the analysis history table 123a is stored is considered to show an associated analysis procedure. The analysis procedure ID 509 is assigned with a numeric character, as an example.

### (FIG. 6)

The analysis purpose table 123b is created for each set analysis purpose, and stores an analysis purpose and analysis purpose information to be collected in the malware analysis according to the purpose. The analysis purpose table 123b stores a record that contains, as fields, the analysis purpose ID 508, an analysis purpose 602, a recommended analysis purpose information 603, and analysis purpose information 604.

The analysis purpose ID 508 is a field that stores an identifier assigned to uniquely identify one malware purpose. The analysis purpose ID 508 is assigned with a numeric character, as an example.

The analysis purpose 602 stores analysis purpose information related to a purpose of the user to perform the malware analysis. The analysis purpose 602 includes, for example, incident response and blacklist update.

The recommended analysis purpose information 603 is a field that stores recommended analysis purpose information recommended by the analysis purpose information recommendation unit 203 (FIG. 2). Note that the recommended analysis purpose information 603 is used in the second embodiment, and therefore the column for the recommended analysis purpose information 603 may be blank in the first embodiment. The analysis purpose information as used herein refers to the type of information that corresponds to the set analysis purpose and is collected through the malware analysis to achieve the set analysis purpose. The recommended analysis purpose information 603 stores a domain name of an attacker server, and a malware persistence method, for example.

The analysis purpose information 604 is a field that stores analysis purpose information actually set by the user. The analysis purpose information 604 stores a domain name of an attacker server, and a malware persistence method (functions of malware for causing the malware to operate again after the stop), for example.

### (FIG. 7)

The analysis procedure table 123c stores information related to a malware analysis procedure, the information being created for each series of malware analysis procedures. The analysis procedure table 123c stores a record that contains, as fields, an analysis procedure ID 509, analysis purpose information 702, an analysis environment 703, a family name 704, a recommended analysis procedure 705, an analysis procedure 706, a tool 707, and a result 708.

The analysis procedure ID 509 is a field that stores an identifier assigned to uniquely identify a series of malware analysis procedures. The analysis procedure ID 509 is assigned with a numeric character, as an example.

The analysis purpose information 702 is a field that stores analysis purpose information actually set by the user. The analysis purpose information 702 stores a domain name of an attacker server, and a malware persistence method, for example.

The analysis environment 703 is a field that stores information related to the malware analysis environment 130. The analysis environment 703 stores a sandbox name, an analysis environment name, or an identifier assigned to identify the environment, for example.

The family name 704 stores information related to a family and version of malware to be analyzed. The family name 704 stores FormBook, or AgentTesla, for example. When a family of malware to be analyzed is unknown, result information indicating unknown, NONE, or the like may be stored in the family name 704.

The recommended analysis procedure 705 is a field that stores a malware analysis procedure for the recommended analysis procedure creation unit 202 to recommend an analysis procedure to the user. The recommended analysis procedure 705 stores, for example, a task related to the malware analysis such as domain search on a reputation site or a communication log analysis.

The analysis procedure 706 is a field that stores a malware analysis procedure. The analysis procedure 706 stores, for example, a task related to the malware analysis such as domain search on a reputation site and a communication log analysis.

The tool 707 is a field that stores, corresponding to each procedure of the analysis procedure 706, a tool utilized or a WEB page name browsed in the procedure. The tool 707 stores a name of the reputation site, a name of a tool used for communication logging, and a name of a tool used for analysis.

The result 708 is a field that stores, corresponding to each procedure of the analysis procedure 706, a value obtained as a result of performing the procedure. The result 708 stores example[.]com (a result of performing the procedure for “advance investigation for a domain name candidate of the attacker server on the reputation site”), for example.

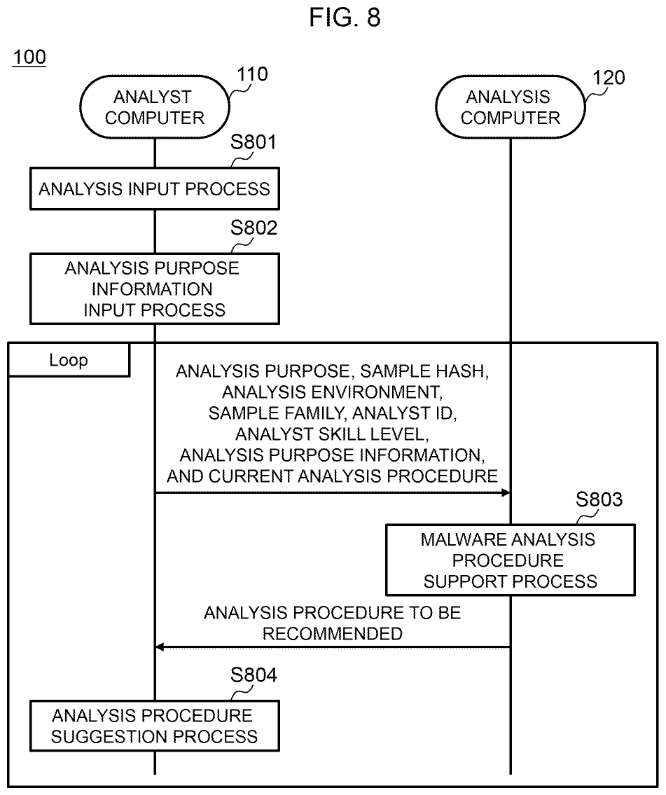

### (FIG. 8)

In a sequence diagram for the malware analysis support system 100 of the present invention illustrated in FIG. 8, processes performed by the analyst computer 110 and the analysis computer 120 and information exchanged between the analyst computer 110 and the analysis computer 120 are illustrated. Note that in the first embodiment of the present invention, in the analyst computer 110, the analysis input unit 301, the analysis purpose input unit 302, and the analysis procedure suggestion unit 303 are used, and in analysis computer 120, the malware analysis procedure support unit 201 and the recommended analysis procedure creation unit 202 are used.

The user inputs analysis conditions related to the malware analysis to the analysis condition input unit 401 displayed on the analysis screen 400 (FIG. 4). The analyst computer 110 causes the analysis input unit 301 (FIG. 3) to execute the analysis input process (see FIG. 9) on the basis of various types of information related to the analysis conditions input by the user (step S801).

Furthermore, the user inputs, to the analysis purpose information input unit 402, the analysis purpose information set for the purpose of the malware analysis, and the analyst computer 110 causes the analysis purpose input unit 302 to execute the analysis purpose information input process (see FIG. 10) on the basis of the analysis purpose information input by the user (step S802).

After step S802, a loop process is executed at an arbitrary timing. The condition that the loop process is executed is when new information is input or when the user inputs update using a button, for example.

After step S802, in a first loop process, the analyst computer 110 transmits, to the analysis computer 120, the information including the analysis purpose, the sample hash, the analysis environment, the sample family, the analyst ID, the analyst skill level, the analysis purpose information, and the current analysis procedure, which are input to the analysis condition input unit 401 and the analysis purpose information input unit 402 displayed on the analysis screen 400. The malware analysis procedure support unit 201 of the analysis computer 120 executes the malware analysis procedure support process (see FIG. 11) on the basis of the received various types of information.

The malware analysis procedure to be recommended to the user that is output in the malware analysis procedure support step is transmitted from the analysis computer 120 to the analyst computer 110. The analyst computer 110 causes the analysis procedure suggestion unit 303 to execute the analysis procedure suggestion process (see FIG. 13) on the basis of the received malware analysis procedure (step S804).

### (FIG. 9)

The analysis input process (FIG. 8, step S801) will be described which is executed in the analyst computer 110 on the basis of various types of information for the malware analysis input by the user to the analysis condition input unit 401 (FIG. 4). The analyst computer 110 presents the analysis condition input unit 401 to the user to cause the user to input the analysis purpose, the sample hash, the analysis environment, the sample family, the analyst ID, and the analyst skill level, which are the analysis conditions (step S901).

The analyst computer 110 determines whether the inputs are provided by the user to the analysis condition input unit 401 (step S902). When it is determined that the inputs are provided (step S902: YES), the process proceeds to step S903. On the other hand, when it is determined that the input is not provided (step S902: NO), the process proceeds to step S901 and the loop process is performed.

The analyst computer 110 transmits, to the analysis computer 120, the analysis purpose, the sample hash, the analysis environment, the sample family, the analyst ID, and the analyst skill level, which are input by the user (step S903).

### (FIG. 10)

The analysis purpose information input process (FIG. 8, step S802) will be described which is executed in the analyst computer 110 on the basis of the analysis purpose information set for the analysis purpose of the malware analysis, the analysis purpose information being input by the user to the analysis purpose information input unit 402 (FIG. 4). The analyst computer 110 presents the analysis purpose information input unit 402 to cause the user to input the analysis purpose information (step S1001). The analysis purpose information is information that corresponds to the malware analysis conditions input by the user and is collected through the malware analysis.

The analyst computer 110 determines whether an input is provided by the user to the analysis purpose information input unit 402 (step S1002). When it is determined that the input is provided (step S902: YES), the process proceeds to step S1003.

On the other hand, when it is determined that the input is not provided (step S902: NO), the process proceeds to step S1001 and the loop process is performed.

The analyst computer 110 transmits, to the analysis computer 120, the analysis purpose information input by the user (step S1003).

### (FIG. 11)

The malware analysis procedure support processes (FIG. 8: step S803, step S804) of the malware analysis procedure support unit 201 and the recommended analysis procedure creation unit 202 (FIG. 2) will be described which are executed in the analysis computer 120.

After the processes of step S903 (FIG. 9) and step S1003 (FIG. 10) which are executed in the analyst computer 110, the malware analysis procedure support unit 201 acquires, from the analyst computer 110, the analysis conditions and the analysis purpose information (the analysis purpose, the sample hash, the analysis environment, the sample family, the analyst ID, the analyst skill level, and the analysis purpose information list) (step S1101).

The malware analysis procedure support unit 201 updates the analysis purpose 602 and the analysis purpose information 604 in the analysis purpose table 123b (FIG. 6), and further updates the analysis purpose 502, the sample hash 503, the sample family 504, the analysis environment 505, the analyst ID 506, and the analyst skill level 507 in the analysis history table 123a (step S1102).

Note that when the information related to the analysis purpose of the malware analysis has not previously been registered, the analysis computer 120 newly creates a column, and acquires a current analysis procedure input to the analysis procedure input and suggestion unit 403 in the analyst computer 110 (step S1103).

The recommended analysis procedure creation unit 202 refers to the analysis procedure table 123c (FIG. 7), and acquires a past analysis procedure (step S1104). The recommended analysis procedure creation unit 202 executes the recommended analysis procedure creation process of calculating and creating an analysis procedure to be recommended to the user on the basis of the past analysis procedure acquired from the analysis procedure table 123c, the analysis conditions and the analysis purpose information input by the user, the current analysis procedure (step S1105).

The analysis computer 120 transmits, to the analyst computer 110, the analysis procedure to be recommended to the user, created in the recommended analysis procedure creation process (step S1106).

### (FIG. 12)

The recommended analysis procedure creation unit 202 of the analysis computer 120 will be described. When the process of the analysis procedure suggestion unit 303 of the analyst computer 110 is executed (which will be described later using FIG. 13), the recommended analysis procedure creation unit 202 of the analysis computer 120 executes the analysis procedure suggestion process of extracting an analysis procedure similar to the past analysis procedure with respect to each piece of information in the analysis purpose information list input by the user, to recommend it to the user (step S1201).

Note that the analysis purpose information, the analysis environment, the family name, and the current malware analysis procedure are utilized to determine whether the analysis procedure to be extracted is similar to the past analysis procedure. For example, the graph neural network is used for the method of recommending the malware analysis procedure, but the present invention does not depend on this algorithm.

### (FIG. 13)

The process of the analysis procedure suggestion unit 303 of the analyst computer 110 will be described. When the analysis procedure suggestion process (FIG. 12; step S1201) is executed by the recommended analysis procedure creation unit 202 of the analysis computer 120, the analysis procedure suggestion unit 303 of the analyst computer 110 receives the malware analysis procedure to be recommended to the user from the analysis computer 120 (step S1301). The analyst computer 110 outputs the malware analysis procedure to be recommended to the user to the analysis procedure input and suggestion unit 403 (FIG. 4). At the same time, the analyst computer 110 requests the user to input the actual malware analysis procedure, the tool, and the result (step S1302).

The analyst computer 110 determines whether the user inputs are provided to the analysis procedure input and suggestion unit 403 (step S1303). When it is determined that the inputs are provided (step S1303: YES), the process proceeds to step S1304. On the other hand, when it is determined that the inputs are not provided (step S1303: NO), the process proceeds to step S1305.

The analyst computer 110 executes the process of the analysis procedure suggestion unit 303 again on the basis of the actual malware analysis procedure, the tool, and the result input by the user, and instructs the analysis computer 120 to execute the malware analysis procedure support process again (step S1304). At this time, the analysis computer 120 may update the analysis procedure 706, the tool 707, and the result 708 in the analysis procedure table 123c. When step S1304 is completed, step S1301 is executed again.

When the user inputs are not provided to the analysis procedure input and suggestion unit 403 (FIG. 4), the analyst computer 110 determines whether all of the user inputs are completed (step S1305). When the inputs are completed (step S1303: YES), the flow is ended. On the other hand, when the inputs are not completed (step S1303: NO), step S1302 is executed.

As described above, the present invention recommends, to the user, the analysis procedure similar to the past analysis procedure on the basis of the malware analysis conditions and the analysis purpose information input by the user, and the past and current malware analysis procedures. The present invention performs the process of creating the malware analysis procedure to be recommended to the user again while reflecting the actual analysis procedure, the tool, and the result input by the user. This enables the malware analysis support system 100 to efficiently perform the malware analysis while reflecting the conditions of the malware analysis.

Note that the analysis computer 120 may compare between the past malware analysis procedure and the current malware analysis procedure to calculate a progress ratio of the malware analysis procedure, so that the analyst computer 110 displays the calculated progress ratio of the malware analysis procedure to the user.

### Second Embodiment

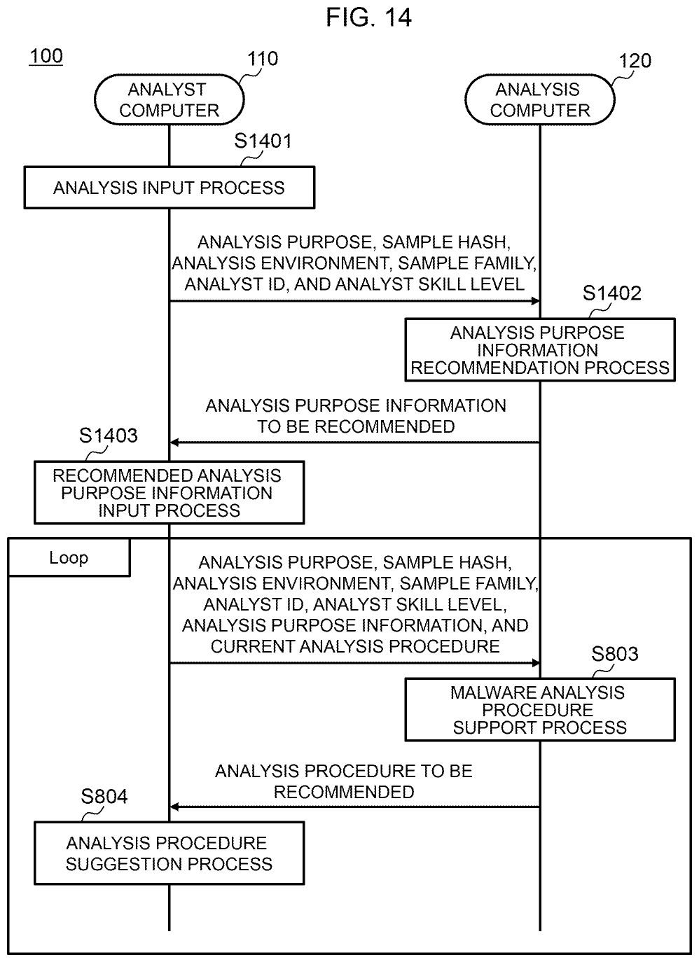

### (FIG. 14)

A malware analysis support system 100 according to the second embodiment recommends, to a user, analysis purpose information corresponding to the purpose of a malware analysis. Note that in the second embodiment, in addition to each function unit of the analyst computer 110 and the analysis computer 120 used in the first embodiment, a recommended analysis purpose information input unit 304 (FIG. 3) is used in the analyst computer 110, and an analysis purpose information recommendation unit 203 (FIG. 2) is used in the analysis computer 120.

The analysis purpose information recommendation unit 203 of the analysis computer 120 executes the analysis purpose information recommendation process of calculating analysis purpose information to be set on the basis of the analysis purpose input by the user to recommend it to the user (details will be described later using FIG. 15).

The recommended analysis purpose information input unit 304 of the analyst computer 110 executes the recommended analysis purpose information input process (details will be described later using FIG. 16). In the recommended analysis purpose information input process, first, the recommended analysis purpose information input unit 304 acquires recommended analysis purpose information to be recommended to the user, calculated by the analysis purpose information recommendation unit 203, and outputs and presents it to the analysis purpose information input unit 402 (FIG. 4). Then, the user inputs, to the analysis purpose information input unit 402, the analysis purpose information determined on the basis of the output and presented recommended analysis purpose information.

A sequence diagram of the malware analysis support system 100 of the second embodiment will be described. The analyst computer 110 transmits, to the analysis computer 120, the information including the analysis purpose, the sample hash, the analysis environment, the sample family, the analyst ID, and the analyst skill level, which are input in the analysis input process (step S1401). The analysis computer 120 causes the analysis purpose information recommendation unit 203 (FIG. 2) to execute the analysis purpose information recommendation process on the basis of the information received from the analyst computer 110 (step S1402).

The analysis computer 120 transmits, to the analyst computer 110, the recommended analysis purpose information to be recommended to the user, calculated in the analysis purpose information recommendation process. The analyst computer 110 executes the recommended analysis purpose information input process on the basis of the acquired recommended analysis purpose information (step S1403). The subsequent loop process is the same as the above-described loop process in FIG. 8 in the first embodiment.

### (FIG. 15)

A process flow of the analysis computer 120 (FIG. 14: step S1402) will be described. The analysis purpose information recommendation unit 203 of the analysis computer 120 acquires, from the analyst computer 110, the analysis purpose, the sample hash, the analysis environment, the sample family, the analyst ID, and the analyst skill level (step S1501).

The analysis purpose information recommendation unit 203 updates the analysis purpose, the sample hash, the analysis environment, the sample family, the analyst ID, and the analyst skill level in the analysis history table 123a on the basis of each piece of information acquired from the analyst computer 110 (step S1502).

The analysis purpose information recommendation unit 203 refers to the analysis purpose table 123b (FIG. 6) and acquires, from the analysis purpose table 123b, the analysis purpose information in a row having an analysis purpose consistent with the analysis purpose acquired from the analyst computer 110 as a list (step S1503). The analysis purpose information recommendation unit 203 calculates the recommended analysis purpose information to be recommended to the user on the basis of the analysis purpose information list acquired from the analysis purpose table 123b (step S1504). Note that the analysis purpose information recommendation unit 203 utilizes the algorithm such as collaborative filtering when calculating the analysis purpose information to be recommended, but the present invention does not depend on this type of algorithm.

The analysis purpose information recommendation unit 203 updates the recommended analysis purpose information 603 in the analysis purpose table 123b to the recommended analysis purpose information calculated in step S1504 (step S1505). The analysis purpose information recommendation unit 203 transmits, to the analyst computer 110, the recommended analysis purpose information calculated in step S1504 (step S1506).

### (FIG. 16)

A process flow of the analyst computer 110 (FIG. 14: step S1403) will be described. The recommended analysis purpose information input unit 304 (FIG. 3) of the analyst computer 110 executes the recommended analysis purpose information input process. The recommended analysis purpose information input unit 304 outputs the recommended analysis purpose information received from the analysis computer 120 to the analysis purpose information input unit 402 (FIG. 4) to present it to the user (step S1601).

The recommended analysis purpose information input unit 304 determines whether the user has input the analysis purpose information to the analysis purpose information input unit 402 on the basis of the recommended analysis purpose information presented to the user (step S1602). When it is determined that the input is provided (step S1602: YES), the process proceeds to step S1603. On the other hand, when it is determined that the input is not provided (step S1602: NO), the process proceeds to step S1601 and the loop process is performed.

When the user inputs the analysis purpose information, the recommended analysis purpose information input unit 304 transmits the input analysis purpose information to the analysis computer 120 (step S1603). The subsequent processes are the same as those in the first embodiment.

As described above, according to the second embodiment, the malware analysis support system 100 presents the recommended analysis purpose information to the user on the basis of the malware analysis purpose input by the user, which makes it possible to provide more efficient malware analysis support for the user who has a clear malware analysis purpose but does not know how to collect the analysis purpose information.

### Third Embodiment

In the third embodiment, the analysis procedure execution unit 204 (FIG. 2) of the analysis computer 120 predefines a method of executing a part of a malware analysis procedure and automatically executes an analysis procedure according to the defined execution method for the purpose of reducing a user's burden of performing the malware analysis procedure.

The analysis procedure execution process of the analysis procedure execution unit 204 describes, as a program, API cooperation with the reputation site in advance, and automatically acquires the reputation of the malware to be analyzed when executing the procedure of investigating the reputation of the malware to be analyzed, and suggests the information to the user, for example. Note that the analyst computer 110 may have a function of determining the authenticity on the basis of the information thus automatically acquired and suggested.

The procedure input auxiliary function unit 305 (FIG. 3) of the analyst computer 110 tracks the work in the analyst computer 110 and automatically creates a current analysis procedure, for the purpose of reducing a burden imposed on the user. The procedure input auxiliary function process of the procedure input auxiliary function unit 305 records (tracks) the access history of the browser, the execution history of the command, and the execution history of the application, and creates the current analysis procedure from the histories, for example.

Thus, the malware analysis support system 100 tracks the analysis procedure and automatically execute the input of the current analysis procedure, and automatically performs the analysis procedure according to the predefined contents of the work to be performed by the user, which makes it possible to provide the malware analysis support with less burden on the user.

### Fourth Embodiment

In the fourth embodiment, the analysis report is created and the operation to the external security device is executed for the purpose of the user's support after the malware analysis. The analysis report creation unit 205 (FIG. 2) of the analysis computer 120 creates an analysis report on the basis of a template of the analysis report predefined for each analysis purpose and the analysis procedure 706, the tool 707, and the result 708 in the analysis procedure table 123c. The report template defines the result corresponding to the analysis procedure by a variable, for example, and is provided in a form of substituting the result 708 in the analysis procedure table 123c.

The external device cooperation unit 206 (FIG. 2) of the analysis computer 120 cooperates with the external security device on the basis of the analysis procedure 706, the tool 707, and the result 708 in the analysis procedure table 123c for the purpose of updating the blacklist for the malware to be analyzed, or the like. The external device cooperation process of the external device cooperation unit 206 uses the API of the external security device, for example, and adds a domain name of the attacker server to the blacklist when the domain name is found.

The reaction suggestion unit 306 (FIG. 3) of the analyst computer 110 presents the analysis report created by the analysis report creation unit 205 to the user and requests the user to determine whether to execute the external device cooperation process in the external device cooperation unit 206. This enables the malware analysis support system 100 to provide the malware analysis support with less burden on the user.

The embodiments of the present invention as described above exhibit the following effects.
(1) In a malware analysis support system 100 which supports a malware analysis of a user using an analyst computer 110 and an analysis computer 120, the analyst computer 110 includes an analysis input unit 301 configured to input analysis conditions of the malware analysis, an analysis purpose input unit 302 configured to input analysis purpose information that is information corresponding to a malware analysis purpose included in the analysis conditions and collected through the malware analysis, and an analysis procedure suggestion unit 303 configured to display an analysis procedure of the malware analysis. The analysis computer 120 includes a recommended analysis procedure creation unit 202 configured to execute a process for calculating the analysis procedure to be recommended to the user on a basis of the analysis conditions, the analysis purpose information, a past analysis procedure, and a current analysis procedure. The analysis procedure suggestion unit 303 recommends, to the user, the analysis procedure calculated by the recommended analysis procedure creation unit. This makes it possible to provide the malware analysis support system that can efficiently perform the malware analysis while reflecting the conditions of the malware analysis.
(2) The analysis computer 120 includes an analysis purpose information recommendation unit 203 configured to calculate recommended analysis purpose information for being recommended to the user on the basis of the analysis purpose information input by the analyst computer 110. The analyst computer 110 includes a recommended analysis purpose information input unit 304 configured to present the calculated recommended analysis purpose information to the user and accept the analysis purpose information input by the user on the basis of the recommended analysis purpose information. This makes it possible to provide the malware analysis support with less burden on the user.
(3) The analyst computer 110 includes a procedure input auxiliary function unit 305 configured to track work in the analyst computer 110 and automatically create the current analysis procedure. This makes it possible to reduce the burden on the user.
(4) The analysis computer 120 includes an analysis procedure execution unit 204 configured to predefine a method of executing a part of the analysis procedure and automatically execute the analysis procedure according to the defined execution method. This makes it possible to reduce the burden on the user.
(5) The analysis computer 120 includes an analysis report creation unit 205 configured to create an analysis report on the basis of a result of the malware analysis and present the analysis report to the user. This makes it possible to provide the malware analysis support with less burden on the user.
(6) The analysis computer 120 includes an external device cooperation unit 206 configured to cooperate with an external security device on the basis of the result of the malware analysis. This makes it possible to provide the malware analysis support with less burden on the user.
(7) The analyst computer 110 calculates a progress ratio of the malware analysis procedure from the past malware analysis procedure and the current malware analysis procedure, and presents the calculated progress ratio of the malware analysis procedure to the user. This makes it possible to efficiently perform the malware analysis while reflecting the conditions of the malware analysis.
(8) In a malware analysis support method of supporting a malware analysis of a user using an analyst computer 110 and an analysis computer 120, the analyst computer 110 accepts, from the user, analysis conditions of the malware analysis and analysis purpose information that is information corresponding to a malware analysis purpose included in the analysis conditions and collected through the malware analysis. The analysis computer 120 calculates the analysis procedure to be recommended to the user from the analysis conditions, the analysis purpose information, a past analysis procedure, and a current analysis procedure, and the analyst computer 110 adopts a method of recommending the calculated analysis procedure to the user. This makes it possible to provide the malware analysis support method that can efficiently perform the malware analysis while reflecting the conditions of the malware analysis.

Note that the present invention is not limited to the above-described embodiments, and can be variously modified or combine the other features without departing from the scope of the present invention. The present invention is not limited embodiments having all of the above-described features of the above-described embodiments, but encompasses embodiments that do not have some of the features.

### REFERENCE SIGNS LIST

100 Malware analysis support system
110 Analyst computer
120 Analysis computer
130 Malware analysis environment

What is claimed is:

1. A malware analysis support system which supports a malware analysis of a user using an analyst computer and an analysis computer, wherein
the analyst computer includes an analysis input unit configured to input analysis conditions of the malware analysis, an analysis purpose input unit configured to input analysis purpose information that is information corresponding to a malware analysis purpose included in the analysis conditions and collected through the malware analysis, and an analysis procedure suggestion unit configured to display an analysis procedure of the malware analysis,
the analysis computer includes a recommended analysis procedure creation unit configured to execute a process for calculating the analysis procedure to be recommended to the user on a basis of the analysis conditions, the analysis purpose information, a past analysis procedure, and a current analysis procedure, and
the analysis procedure suggestion unit recommends, to the user, the analysis procedure calculated by the recommended analysis procedure creation unit.

2. The malware analysis support system according to claim 1, wherein
the analysis computer includes an analysis purpose information recommendation unit configured to calculate recommended analysis purpose information for being recommended to the user on the basis of the analysis purpose information input by the analyst computer, and
the analyst computer includes a recommended analysis purpose information input unit configured to present the calculated recommended analysis purpose information to the user and accept the analysis purpose information input by the user on the basis of the recommended analysis purpose information.

3. The malware analysis support system according to claim 2, wherein
the analyst computer includes a procedure input auxiliary function unit configured to track work in the analyst computer and automatically create the current analysis procedure.

4. The malware analysis support system according to claim 3, wherein
the analysis computer includes an analysis procedure execution unit configured to predefine a method of executing a part of the analysis procedure and automatically execute the analysis procedure according to the defined execution method.

5. The malware analysis support system according to claim 2, wherein
the analysis computer includes an analysis report creation unit configured to create an analysis report on the basis of a result of the malware analysis and present the analysis report to the user.

6. The malware analysis support system according to claim 5, wherein
the analysis computer includes an external device cooperation unit configured to cooperate with an external security device on the basis of the result of the malware analysis.

7. The malware analysis support system according to claim 1, wherein
the analyst computer calculates a progress ratio of the analysis procedure from the past analysis procedure and the current analysis procedure, and presents the calculated progress ratio to the user.

8. A malware analysis support method of supporting a malware analysis of a user using an analyst computer and an analysis computer, wherein
the analyst computer accepts, from the user, analysis conditions of the malware analysis and analysis purpose information that is information corresponding to a malware analysis purpose included in the analysis conditions and collected through the malware analysis,
the analysis computer calculates the analysis procedure to be recommended to the user from the analysis conditions, the analysis purpose information, a past analysis procedure, and a current analysis procedure, and
the analyst computer recommends the calculated analysis procedure to the user.
